(19) United States
(12) Patent Application Publication
(10) Pub. No.: US 2026/0102788 A1
(43) Pub. Date: Apr. 16, 2026

(54) METHOD OF INTERNAL LINING OF CONTAINERS AND LINING APPARATUS

(71) Applicant: Walter Tosto S.p.A., Chieti Scalo, Chieti (IT)

(72) Inventor: Luca TOSTO, Chieti Scalo, Chieti (IT)

(73) Assignee: Walter Tosto S.p.A., Chieti Scalo, Chieti (IT)

(21) Appl. No.: 19/115,388

(22) PCT Filed: Sep. 25, 2023
(86) PCT No.: PCT/IT2023/050216

§ 371 Date: Mar. 26, 2025

(30) Foreign Application Priority Data
Sep. 28, 2022 (IT) 102022000019962

(51) Int. Cl. B05D 7/22; B05D 1/00; B05D 3/02; B05D 3/04; F17C 1/00

(52) U.S. Cl. CPC B05D 7/227; B05D 1/002; B05D 3/0272; B05D 3/0413; B05D 3/0426; F17C 1/00; B05D 2401/32; F17C 2203/0604; F17C 2209/225; F17C 2221/012; F17C 2221/017

(57) ABSTRACT

The present invention concerns a method of lining (4) a container (2) for gas, such as hydrogen, helium, and the like, comprising the following steps: inserting (41) a powder of lining material (P) in a container (2); applying (42) the lining material (P) on the inner surface of the container (2); and fixing (43) the lining material (P) on the inner surface (211) of the container (2).

The present invention also concerns an apparatus (1) for the lining of a tank (2) for the containment of high-pressure gases.

### FIELD OF INVENTION

The present invention relates to a method of internal lining of containers and lining apparatus.

More specifically, the invention concerns a method and system of the aforementioned type, designed and created in particular to allow the lining of metal containers intended to contain light gases such as hydrogen or helium, at high pressure, but which can be used for any application where it is necessary to obtain a very high seal.

In the following,, the description will be directed to the creation of containers for high-pressure hydrogen, in the terms better specified below, but it is clear that the same should not be considered limited to this specific use.

### PRIOR ART

One of the major critical issues in the storage of hydrogen in the gaseous state is the potential embrittlement effect it can cause due to diffusion in the metallic material. This phenomenon can also be related to the pressure level considered for storage.

One solution would be to provide a protection inside the tank, to be applied to the metal part to prevent this potential phenomenon, i.e. the application on the internal surface of a suitable polymer, which at the same time has the property of significantly reducing the permeation of the hydrogen in the metal support, thus substantially reducing the phenomenon of hydrogen embrittlement, low tendency to aging, good cohesion with the metal support, and substantial lack of influence of hydrogen on the chemical and physical characteristics.

Currently there are containers or tanks for hydrogen made of aluminum alloys, which can contain hydrogen at a pressure of 700 bar.

However, these containers do not have sufficient sealing performance for the storage of large volumes of hydrogen, and for long times, with large dimensions in order to guarantee full and continuous availability.

It seems clear that the sector is felt the possibility of having containers capable of containing light gases such as hydrogen or helium, at high pressure.

The relevant prior art also includes patent applications EP 1031384 A2, EP 0778088 A2, JP S62121680 A, EP 0826433 B1, US 2014/332540 A1, U.S. Pat. No. 5,037,600 A, and US 2016/023381 A1.

### SCOPE OF THE INVENTION

In light of the above, it is, therefore, the scope of the present invention to propose a method for lining metal containers that has containment performances superior to those of common methods according to the prior art.

A further scope of the present invention is to provide the tools necessary for carrying out the method and the apparatus which carry out this method.

### OBJECT OF THE INVENTION

It is, therefore, specific object of the present invention a method of lining a container for gas, such as hydrogen, helium, and the like, comprising the following steps: inserting a powder of lining material in a container; applying the lining material on the inner surface of the container; and fixing the lining material on the inner surface of the container.

Always according to the invention, said applying step of the lining material may comprise the sub-steps of: heating the container and the lining material contained until it becomes liquid at a first temperature and for a first time interval; moving the container, so that the lining material adheres to the internal surface of said container; cooling the container, bringing the container to a second temperature, for a second time interval; and moving the container or tank.

Still according to the invention, said heating step may be carried out in a cooking chamber and by means of air; said moving steps may be performed by means of a support unit, to which said container is fixed; and said cooling step may be carried out in a cooling chamber by means of air.

Advantageously according to the invention, said first temperature may be about 220° C.

Further according to the invention, said first time interval may be about 30 minutes.

Always according to the invention, said second temperature may be about 20° C.

Further according to the invention, said second time interval may be about 30 minutes.

Advantageously according to the invention, said fixing step may comprise the sub-steps of: introducing a gas, such as air and the like, at a first pressure, and at a third temperature; and inserting a gas, such as air and the like, at a second pressure, and at a fourth temperature lower than said third temperature.

Preferably according to the invention, said first pressure may be about 2.5 bar and said third temperature is about 80° C., and said second pressure may be about 3 bar and said fourth temperature is about 20° C.

Always according to the invention, said lining material may be a polymer, such as polyethylene (PE), one of the polymers used as a protective lining to avoid or limit the penetration of hydrogen.

Still according to the invention, said fixing step of the lining material on the internal surface of the container may take place by means of a control system of the pressure.

Advantageously according to the invention, said method may comprise a pressure regulator, which can be applied to the access channel of a first closing port of a container, and a safety valve, applicable on the access channel of a second closing port.

It is also object of the present invention an apparatus for lining a tank for containing high-pressure gas, comprising a rotating base, capable of rotating around a vertical axis, at least one support unit, to support at least one tank to be lined and to move it in the space, a cooking chamber, to contain said support unit, to increase the temperature of said tank, and a cooling chamber, for cooling said tank.

Always according to the invention, said at least one support unit may comprise a rotating support, rotatably coupled to the rotating base, so that said support unit can rotate around a first rotation axis, and a gripping structure, having two arms, at the ends of which there is a respective joint, and two anchoring members, each having a first end rotatably coupled to a respective joint of said arm, and a second end, fixed to said tank, wherein said anchoring members are configured, in use, to rotate said tank around a second rotation axis, not parallel to said first rotation axis.

Still according to the invention, said cooking chamber may comprise a cooking compartment, defined by thermal walls, an inlet door for the entry of a support unit, and an exit door, for the exit of a support unit.

Advantageously according to the invention, said cooling chamber may comprise a cooking compartment, delimited by thermal walls, an inlet door, for the entry of a support unit, and an exit door, for the exit of a support unit.

Further according to the invention, said apparatus may comprise three support units.

### BRIEF DESCRIPTION OF THE FIGURES

The present invention will be now described, for illustrative but not limitative purposes, according to its preferred embodiments, with particular reference to the figures of the enclosed drawings, wherein:

FIG. 1 shows a top view of an embodiment of an apparatus for the internal lining of containers according to the present invention;

FIG. 2 shows a step of the method for the internal lining of a container according to the present invention relating to the opening of a tank;

FIG. 3 shows a step of the method for the internal lining of a container according to the present invention relating to the loading of the polymer powder into the tank;

FIG. 4 shows a step of the method for the internal lining of a container according to the present invention relating to the closure of the tank;

FIG. 5 shows a phase of the method for the internal lining of a container according to the present invention relating to the heating and movement of the tank;

FIG. 6 shows a step of the method for the internal lining of a container according to the present invention relating to the installation of a pressure control system;

FIG. 7 shows a step of the method for the internal lining of a container according to the present invention relating to the insertion of hot air at high pressure;

FIG. 8 shows a step of the method for the internal lining of a container according to the present invention relating to the insertion of hot air at high-pressure;

FIG. 9 shows a step of the method for the internal lining of a container according to the present invention relating to the insertion of air at room temperature at high pressure;

FIG. 10 shows a step of the method for the internal lining of a container according to the present invention relating to the disassembly of the closing ports of the tank;

FIG. 11 shows a step of the method for the internal lining of a container according to the present invention relating to the trimming of the ports;

FIG. 12 shows a step of the method for the internal lining of a container according to the present invention relating to the trimming of the port and its removal;

FIG. 13 shows a step of the method for the internal lining of a container according to the present invention relating to the sealing of the tank;

FIG. 14 shows a flowchart of the method of lining a container according to the present invention;

FIG. 15 shows a flow diagram of the sub-steps of applying the polymer to the internal surface of a container;

FIG. 16 shows a flow diagram of the sub-steps of fixing the polymer on the internal surface of the container;

FIG. 17 shows a pressure-temperature graph during the fixing steps of the polymer on the internal surface of the container.

### DETAILED DESCRIPTION

In the various figures the similar parts will be indicated with the same numerical references.

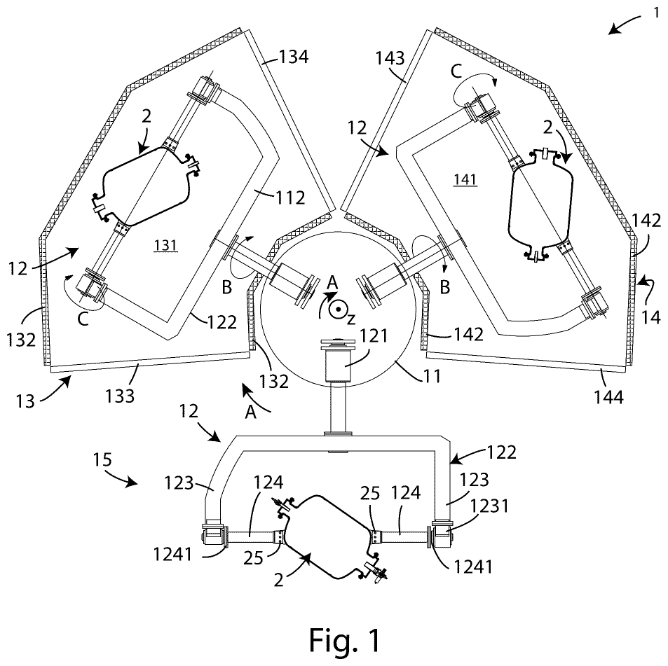

Referring to FIG. 1, an embodiment of a lining apparatus 1 for the internal lining of containers 2, according to the present invention, is observed. The lining apparatus 1 is suitable for carrying out the method of lining tanks or containers in general, as will be better described below.

In the present embodiment, in particular, a tank 2 for containing hydrogen is lined.

The lining apparatus 1 can be made according to other structures or embodiments.

Referring again to FIG. 1, it can be observed how the lining apparatus 1 according to the present embodiment essentially comprises a rotating base 11, three support units 12, a cooking chamber 13, a cooling chamber 14, and an loading and unloading area 15.

The rotating base 11 is able to rotate around a vertical axis Z in the direction of rotation according to the arrow indicated with the letter A. Electric motor means (not shown in the figure) are provided which move the rotating base 11.

Each of the three support units 12 is connected to the rotating base 11 to support a tank 2.

The tank 2 in the case at issue includes walls 21, which define a volume 22 by means of an internal surface 211 and an external surface 212, a first opening 23 and a second opening 24, opposite to said first opening 23, closed with a respective closing port. The closing ports are indicated respectively with the numerical references 231 and 241.

Each closing port 231 and 241 has an internal surface, respectively indicated with the numerical references 232 and 242, and includes a fixing flange, 233 and 243 respectively, for fixing, with appropriate screws, to a respective lip 234 and 244 of the tank 2.

Each closing port 231 and 241 also includes an access channel 235 and 245, whose operation will be better clarified below.

In addition, the tank 2 also includes two anchoring brackets 25, arranged on the external surface 212 of the walls 21, the operation of which will be better clarified below. In the embodiment at issue, the anchoring brackets 25 are welded to the wall 21 of the tank 2. In other embodiments the anchoring brackets 25 can be fixed to said wall 21 by means of any other coupling means.

Each support unit 12 comprises a rotating support 121, rotatably coupled to the rotating base 11, and a gripping structure 122, having two arms 123, at the ends of which a respective joint 1231 is provided.

The support units 12 also comprise two anchoring members 124, each of which has a first end 1241, rotatably coupled to a respective joint 1231 of an arm 123, and a second end 1242, fixed by screws to a respective anchoring bracket 25, welded on the surface 21 of tank 2.

The cooking chamber 13 comprises a cooking compartment 131, made up of thermal walls 132, an inlet door 133 and an outlet door 134.

The cooling chamber 14 comprises a cooking compartment 141, made up of thermal walls 142 and an inlet door 143 and an outlet door 144.

The operation of the lining apparatus 1 described above is as follows.

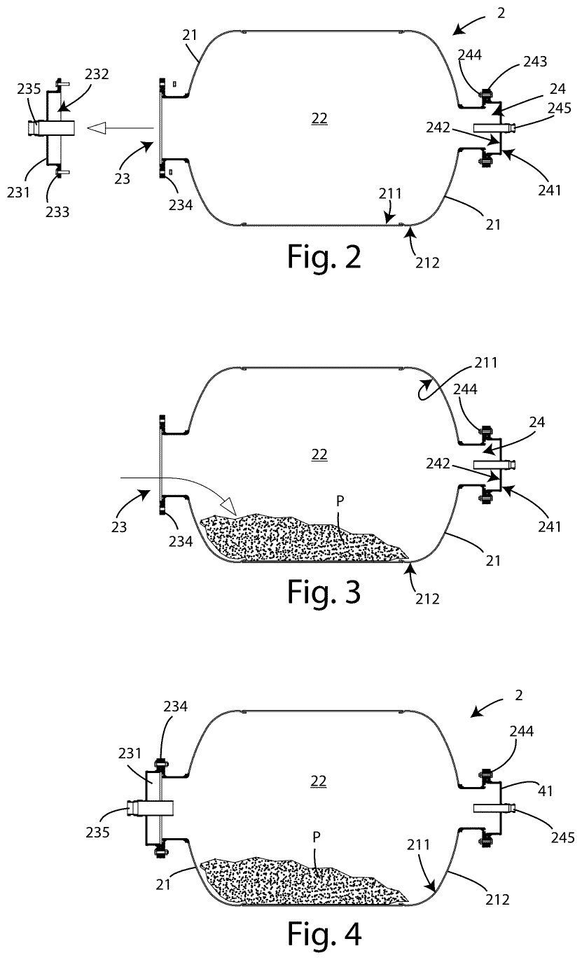

Referring to FIGS. 2, 3, and 4, a tank 2 to be lined is fixed in the loading and unloading area 15 to a support unit 12 by means of the two anchoring brackets 25, fixed to the second end 1242 of the arms 123.

The tank 2 is then opened by removing the first closing port 231, so that the lining material powder, which is generally a polymer, can be inserted into the internal volume 22 through the first opening 23. In the present embodiment the lining material used is a polymer P, such as polyethylene (PE), as the lining material.

Subsequently, the tank 2 is closed and sealed again using the same closing port 231, screwing the tightening screws again to the lip 234 of the tank 2.

In a subsequent step, the support unit 12 is brought into the cooking chamber 13, and in particular inside the cooking compartment 131, in which it is subjected to hot air at a temperature of 220° C., passing through the relevant inlet door 133.

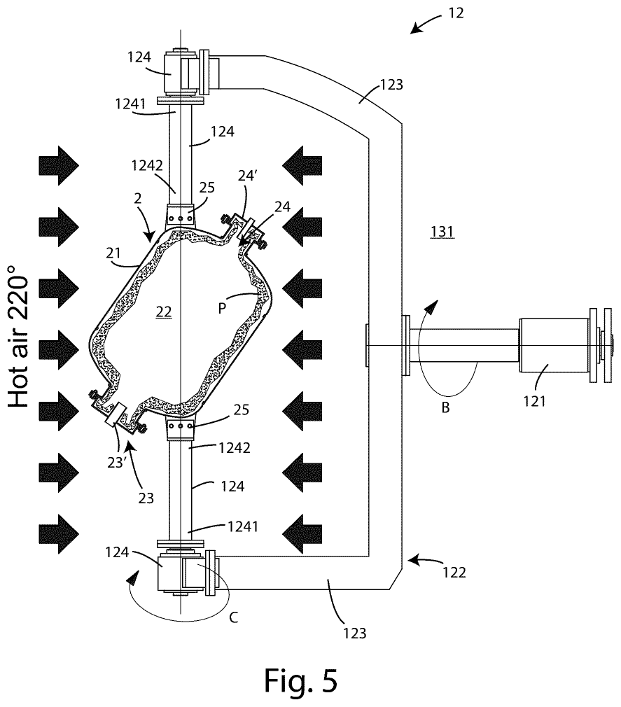

At the same time, the support unit 12 is placed in rotation (see FIG. 5), rotating around both the B axis, through the rotating support 121, and the C axis, which, as mentioned, is perpendicular to the B axis.

In the cooking chamber 13 the polymer melts, reaching the liquid state. Furthermore, the liquid polymer P adheres to the internal surface 211 of the wall 21 of the tank 2, thanks to the rotary movement along the two indicated degrees of freedom.

This allows for optimal adhesion of the polymer P to the walls of the tank 2. Furthermore, the cooking or heating time can be around 30 minutes.

The hot air inside the cooking chamber 13 is generated by hot air emitters and has a temperature of approximately 220° C. (not shown in the figure).

Subsequently, the tank 2 is brought into a cooling chamber 14. In particular, the support unit 12, on which the tank 2 is fixed, is rotated around the Z axis according to the arrow A (see FIG. 1).

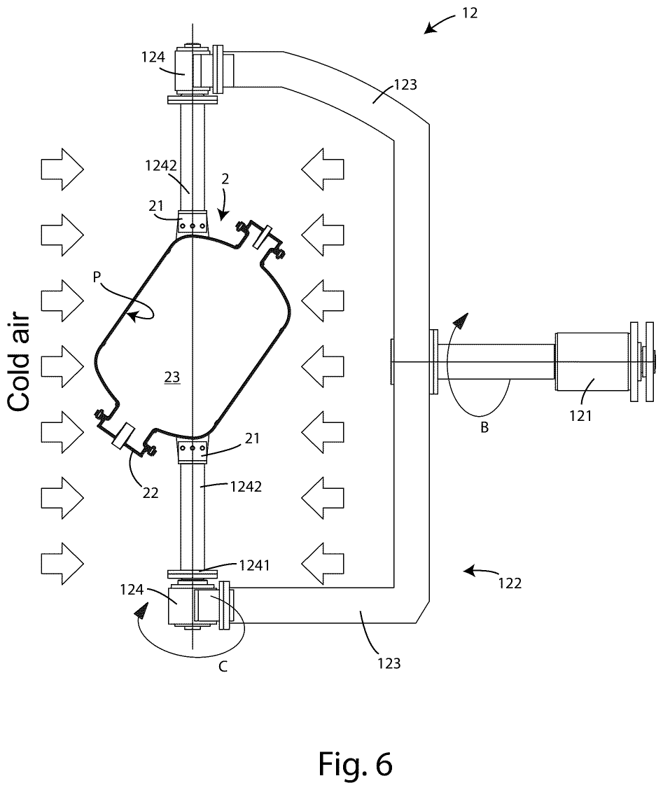

In particular, the support unit 12 exits the cooking chamber 13 through the door 134 and enters the cooling chamber 14 through the door 143. In the cooling chamber, once both the inlet door 143 and the exit door 144 are closed, and referring to FIG. 6, the tank 2 is always placed in rotation around the B axis and the C axis, while cold air is blown onto it. In this way, solidification of the polymer P and optimal adhesion of the same to the internal surface 211 of the wall 21 and to the internal surfaces 232 and 242 of the closing ports 231 and 241 are achieved.

In a cooling time of 30 minutes, the coating with polymer P of the internal surface 211 of the wall 21 of the tank 2, and of the internal surfaces of the closing ports 231 and 241 is completed, which together define the volume 22 of the tank 2. Referring again to FIG. 1, the support unit 12 is brought back into the loading-unloading area 15 always by rotating said support unit 12 around the Z axis, according to arrow A (therefore clockwise). In particular, said support unit 12 is passed through the exit door 144 of the cooling chamber 14.

In this position, in order to allow optimal adhesion of the polymer coating P, as mentioned on the internal surface 211 of the wall 21 of the tank 2, air at a controlled pressure (i.e., greater than atmospheric pressure) is introduced.

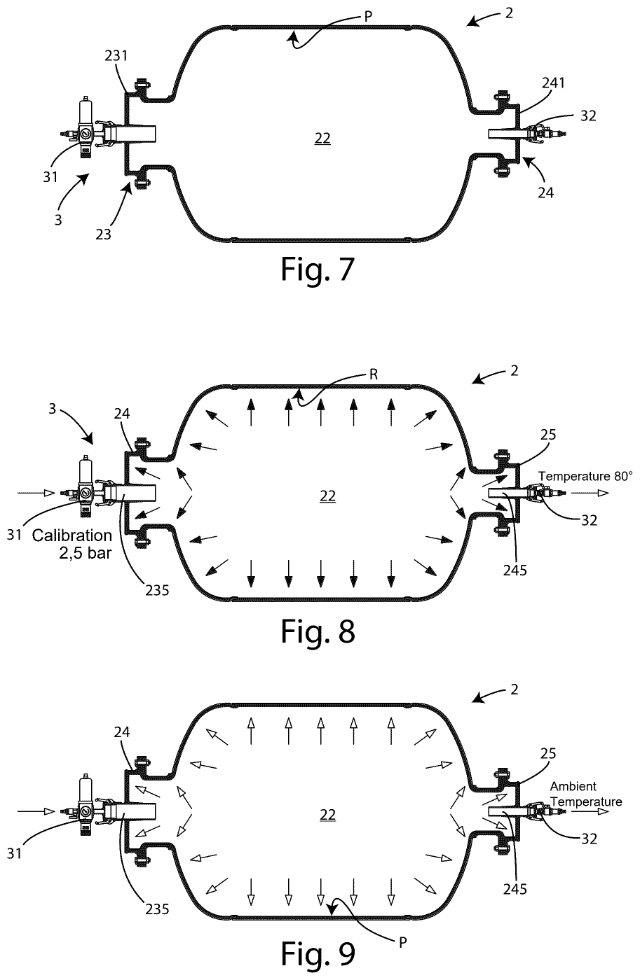

For this purpose, referring to FIG. 7, a pressure control system 3 inside tank 2 is installed on tank 2.

In particular, the pressure control system 3 includes a pressure regulator 31, which is placed on the access channel 235 of the first closing port 231, and a safety valve 32, which is placed on the access channel 245 of the second closing port 241.

In other embodiments, said pressure regulator 31 and said safety valve 32 can also be arranged in different positions.

As can be seen in FIG. 8, hot compressed air is introduced into the volume 22 through the pressure regulator 3, at a temperature of approximately 80° and a pressure of 2.5 bar. The high pressure hot air has the effect of “softening” the lining on the internal surface 211 of the wall 21 of the tank 2, as well as on the internal surfaces 232 and 242 of the first 231 and the second 241 closing port.

In this way, there is the effect of making the P polymer lining uniformly adhere, even in concave, convex or interstitial parts of the aforementioned surfaces, in an optimal way, eliminating or limiting the formation of bubbles or uncoated areas, creating a uniform internal lining R.

The safety valve 32 allows the possible venting of excess air to maintain the pressure at a specified threshold, which is lower than the pressure value with which the air is inserted through said pressure regulator 31.

In particular, in a preferred embodiment, the pressure regulator 31 allows the entry of hot air at a pressure of 2.5 bar, while the safety valve 32 is calibrated to a maximum threshold of 2 bar for safety.

Subsequently, referring to FIG. 9, air enters through the pressure regulator 31 at room temperature, therefore typically between 15° C. and 25° C., at a pressure of 3 bar, always calibrating the safety valve at 2 bar.

This step of introducing air at room temperature, therefore colder than the previous step, and at a pressure greater than atmospheric pressure, allows the internal lining R of polymer P to cool, allowing for optimal adhesion. In other words, the lining R is “kept in adhesion” on the internal surface 211 of the wall of the tank 2 and on the internal surface 232 and 242 of the closing ports 231 and 241, to avoid the possible new formation of bubbles or imperfections in the lining R itself.

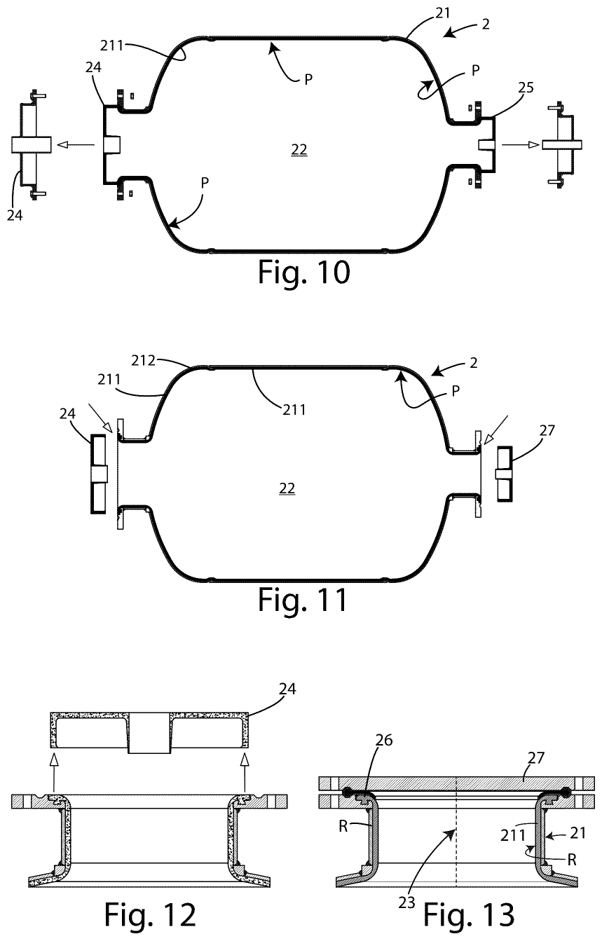

Subsequently, the closing ports 231 and 234 are removed by unscrewing the screws of the flanges 234 and 244 (see FIG. 10). Subsequently, referring to FIGS. 11, 12, and 13, the edges of the openings 23 and 24 are trimmed, to allow the insertion of a gasket 26 by carrying out a respective welding with the polymer of the internal polymer lining R arranged on the surface 211. Finally, a cover 27 is placed fixed with screws to allow the complete sealing of the tank 2.

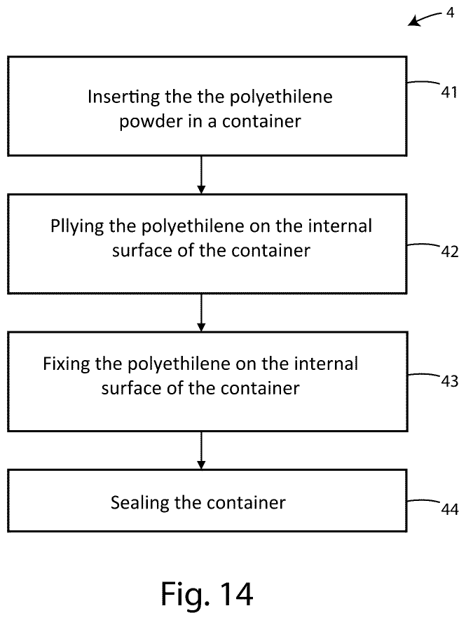

Reference is now made to FIG. 14, which shows in a flowchart the lining method 4 according to the present invention.

In particular, we observe how method 4 provides in general terms the steps of:
inserting 41 the polymer powder P into the tank 2. In the previous embodiment, the insertion step 41 has been described with FIGS. 2, 3 and 4;
applying 42 the polymer P on the internal surface of the tank 2. This application step has been described in FIGS. 5 and 6;
fixing 43 the polymer P, or the chosen liming material, on the internal surface 211 of the tank 2. The fixing step 43 has been described in the previous embodiment with reference to FIGS. 7, 8, and 9;
sealing 44 the tank 2. This sealing step 44 has been described with reference to FIGS. 10,11, 12, and 13.

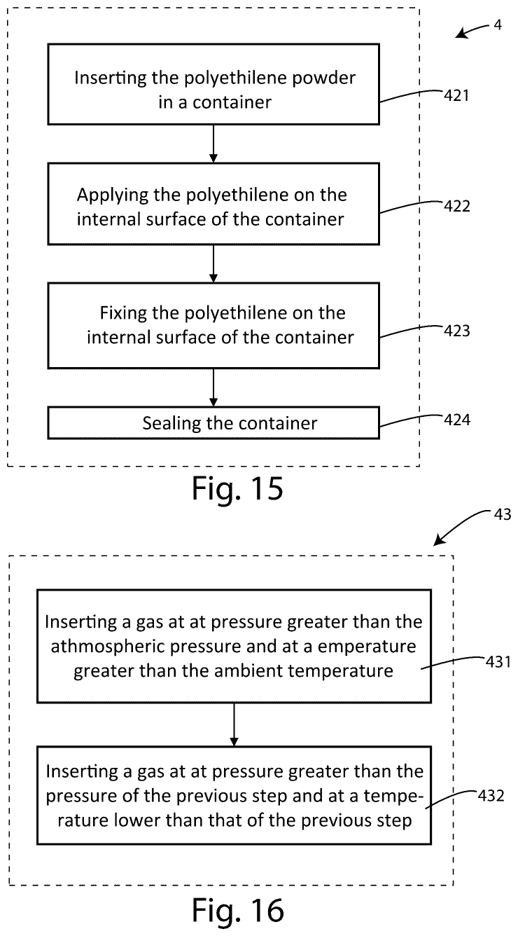

Furthermore, in FIG. 15 the application step 42 of the polymer P is seen in greater detail, which includes, in particular, the steps of heating 421 the tank 2 and the polymer P contained in it until it becomes liquid, and then proceeding with the movement 422 of the tank 2 in the space, so that the liquid polymer covers and adheres to the internal surface 211 of tank 2, or the tank 2. In this step, in consideration of the lining material, a temperature of 220° centigrade is applied, for approximately 30 minutes.

Subsequently, tank 2 is cooled in step 423, bringing tank 2 to room temperature, for a cooling time of approximately 30 minutes. Also in this case, we proceed with the movement (step 424) in the space of the tank 2, to allow optimal cooling of the tank 2 itself.

The fixing step 43 of the lining material (the polymer P) presents the sub-step of inserting a gas (generally air) at a pressure greater than atmospheric pressure, of the order of 2 bar, at a temperature greater than the ambient temperature, which, for the polymer P, is identified as 80° centigrade.

Subsequently, there is the sub-step 432 of insertion of a gas (also in this case air), at a pressure possibly higher than the pressure in step 431, for example 3 bar, and at a lower temperature than the previous one.

By means of steps 431 and 432 the lining R of polymer P, i.e., of the chosen lining material, the lining R is suitably made to adhere optimally to the different internal surface shapes of the tank 2.

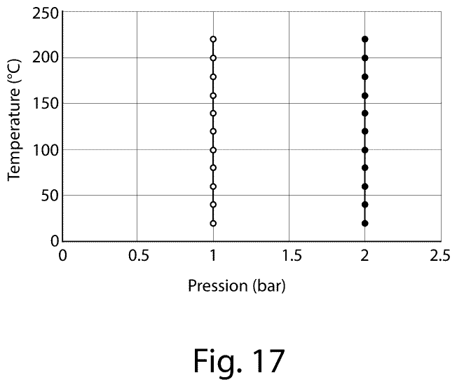

As can be seen in FIG. 17, the heating and cooling temperature varies between 220° C. and 20° C., while the pressure in these steps would be 1 bar and 2 bar. The figure shows the pressure trend in the two different steps.

In other embodiments, different lining materials than polyethylene may be used.

By means of the lining method 4 at issue, it has been experimentally verified that the lined tanks 2 obtained are capable of containing hydrogen at a pressure of at least 700 bar.

### ADVANTAGES

An advantage of the present invention is that it allows an optimal polymer lining of tanks also intended to withstand high pressure, even for very light gases such as hydrogen or helium.

The present invention has been described for illustrative but not limitative purposes, according to its preferred embodiments, but it is to be understood that modifications and/or changes can be introduced by those skilled in the art without departing from the relevant scope as defined in the enclosed claims.

1. Method of lining a container for gas, such as hydrogen, helium, and the like, comprising the following steps:
inserting a powder of lining material (P) in a container;
applying the lining material (P) on the inner surface of the container; and
fixing the lining material (P) on the inner surface of the container;
wherein said applying step of the lining material (P) comprises the sub-steps of:
heating the container and the lining material (P) contained until it becomes liquid at a first temperature and for a first time interval;
moving the container, so that the lining material adheres to the internal surface of said container;
cooling the container, bringing the container to a second temperature, for a second time interval; and
moving the container
wherein
in that said fixing step comprises the sub-steps of:
introducing a gas, such as air and the like, into the container at a first pressure, and at a third temperature; and
inserting a gas, such as air and the like, into the container at a second pressure, and at a fourth temperature lower than said third temperature; and
in that said fixing step of the lining material (P) on the internal surface of the container takes place by means of a control system of the pressure

2. Method according to claim 1, wherein
said heating step is carried out in a cooking chamber and by means of air;
in that said moving steps are performed by means of a support unit, to which said container is fixed; and
in that said cooling step is carried out in a cooling chamber by means of air.

3. Method according to claim 1, wherein said first temperature is about 220° C.

4. Method according to claim 1, wherein said first time interval is about 30 minutes.

5. Method according to claim 1, wherein said second temperature is about 20° C.

6. Method according to claim 1, wherein said second time interval is about 30 minutes.

7. Method according to claim 1, wherein
said first pressure is about 2.5 bar and said third temperature is about 80° C., and
in that said second pressure is about 3 bar and said fourth temperature is about 20° C.

8. Method according to claim 1, wherein said lining material is a polymer, such as polyethylene (PE), one of the polymers used as a protective lining to avoid or limit the penetration of hydrogen.

9. Method according to claim 1, wherein the control system of the pressure comprises
a pressure regulator which can be applied to the access channel of a first closing port of a container, and
a safety valve, applicable on the access channel of a second closing port.

10. Apparatus for lining a container, such as a tank, for containing high-pressure gas, comprising
a rotating base, capable of rotating around a vertical axis,
at least one support unit, to support at least one container to be lined and to move it in the space,
a cooking chamber, to contain said support unit, to increase the temperature of said tank, and
a cooling chamber, for cooling said tank.

11. Apparatus according to claim 10, wherein
said at least one support unit comprises
a rotating support, rotatably coupled to the rotating base so that said support unit can rotate around a first rotation axis (B), and
a gripping structure having two arms, at the ends of which there is a respective joint, and
two anchoring members, each having a first end rotatably coupled to a respective joint of said arm, and a second end, fixed to said tank,
wherein said anchoring members are configured, in use, to rotate said tank around a second rotation axis (C), not parallel to said first rotation axis (B).

12. Apparatus according to claim 10, wherein said cooking chamber comprises a cooking compartment, defined by thermal walls, an inlet door for the entry of a support unit and an exit door, for the exit of a support unit.

13. Apparatus according to claim 10, wherein said cooling chamber comprises a cooking compartment delimited by thermal walls an inlet door, for the entry of a support unit, and an exit door, for the exit of a support unit.

14. Apparatus according to claim 10 further comprising three support units.
